(19) United States
(12) Patent Application Publication
(10) Pub. No.: US 2006/0277387 A1
(43) Pub. Date: Dec. 7, 2006

(54) System and method for hardware allocation of memory resources

(75) Inventor: Robert Todt Rhoades, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NeoScale Systems, Inc., Milpitas, CA (US)

(21) Appl. No.: 11/407,263

(22) Filed: Apr. 18, 2006

Related U.S. Application Data
(60) Provisional application No. 60/672,814, filed on Apr. 18, 2005.

(51) Int. Cl. G06F 12/00

(52) U.S. Cl. 711/170; 711/216

(57) ABSTRACT

System and method for hardware allocation of memory resources. According to an embodiment, the present invention provides a method for allocating memory resources. The method includes a step for providing a plurality of lookup table. Each of the lookup table includes indicators indicating an availability for memory locations. The plurality of lookup table includes at least one top level lookup table and one or more bottom level lookup tables. The method includes a step for providing at least one pointer. The at least one pointer is used to indicate one or more sequential sets of available memory blocks. Additionally, the method includes a step for determining whether a first condition is satisfied. The first condition is associated with an availability of memory blocks being indicated by the at least one pointer. Furthermore, the method includes a step for determining a next pointer if the first condition is satisfied.

### CROSS-REFERENCES TO RELATED APPLICATIONS

This application claims priority to U.S. Provisional Application No. 60/672,814 (Attorney Docket Number 021970-000900US) filed Apr. 18, 2005, in the name of Robert Todt Rhoades, commonly assigned, and hereby incorporated by reference here.

### BACKGROUND OF THE INVENTION

The present invention relates generally to memory allocation techniques. In particular, the present invention provides a system and method for hardware allocation of memory resources. More particularly, the present invention provides a free link manager for the use of memory allocation. Merely by way of example, this invention can be utilized in systems where hardware and software elements share same memory space.

In the history of computer systems, the develop of computer software and hardware has been limited by various constrains. For example, processing power of computer system has been a constraint as how much information a computer is able to process, and software are developed according to stay within this constraint. Memory is another example of system constraints, and the memory constraint usually limits how much information can be processed or stored.

As the technology improves over time, computer systems are now able to process much more information than their predecessors, and they have larger memory units. In a way, constraints to computer processing power has a higher upper limit. However, constraints are still constraints. Various techniques can be used to enable better performance for computer systems with the same constraints. For example, various techniques have been developed for more efficient allocation of available memories.

For example, various memory allocation techniques utilizing tree data structure have been developed to improve memory allocation. As another example, some memory allocation techniques are implemented with pointer sets used as single units. Unfortunately, these techniques are of inadequate.

From the above, it is seen that techniques for improving memory allocation is highly desirable.

### BRIEF SUMMARY OF THE INVENTION

The present invention relates generally to memory allocation techniques. In particular, the present invention provides a system and method for hardware allocation of memory resources. More particularly, the present invention provides a free link manager for the use of memory allocation. Merely by way of example, this invention can be utilized in systems where hardware and software elements share same memory space.

According to an embodiment, the present invention provides a method for allocating memory resources. The method includes a step for providing a plurality of lookup table. Each of the lookup table includes indicators indicating an availability for one or more memory locations. The plurality of lookup table includes at least one top level lookup table and one or more bottom level lookup tables. The method also includes a step for providing at least one pointer. The at least one pointer is used to indicate one or more sequential sets of available memory blocks. Additionally, the method includes a step for determining whether a first condition is satisfied. The first condition is associated with an availability of memory blocks being indicated by the at least one pointer. Furthermore, the method includes a step for determining a next pointer if the first condition is satisfied. To determining the next pointer, the method provides a step to determine whether there is any memory available. The method also provides a step for providing an indicator if there is no more memory available. the method additionally provides a step for searching the at least one top level lookup table. The method additionally includes a step for determining a first pointer portion based on a first result from the searching the at least one top level lookup table. Additionally, the method includes a step for searching one of the bottom lookup tables based on the first result. The method further includes a step for determining a last pointer portion based on a first result from the searching one of the bottom lookup tables. The method furthermore includes a step for providing the next pointer. The next pointer includes the first pointer portion and the last pointer portion. In addition, the method includes a step for setting one or more indicators of the searched one of the bottom lookup tables. Moreover, the method includes a step for providing the next pointer to a request for memory.

It is to be appreciated that the present invention provides various advantages. According to various embodiments, the present inventions provides a more efficient memory allocation technique. In addition, it is also to be appreciated that the present invention may be used in different types of systems. It is also to be noted that the present invention can be flexibly implemented using a wide range of components.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram illustrating timing and operation according to an embodiment of the present invention.

FIG. 2 is a simplified diagram illustrating the process of generating portions of a memory pointer based on lookup table searches according to an embodiment of the present invention.

FIG. 3 is a simplified flowchart diagram illustrating the operation the FLM according to an embodiment of the present invention.

### DETAILED DESCRIPTION OF THE INVENTION

The present invention relates generally to memory allocation techniques. In particular, the present invention provides a system and method for hardware allocation of memory resources. More particularly, the present invention provides a free link manager for the use of memory allocation. Merely by way of example, this invention can be utilized in systems where hardware and software elements share same memory space.

Within shared memory systems, it is often necessary to manage the allocation and deallocation of memory blocks. Usually, the management of memory block is performed by software. The software management often hinders performance of a system, as the software management consumes valuable system resources, including the memory the software manages.

Therefore it is to be appreciated that according various embodiments, the present invention provides a Free List Manager (FLM). The FLM is a hardware construct that performs real-time, dynamic memory allocation and deallocation. Among various advantages, the FLM frees the software from the responsibility of memory allocation and allows hardware to reserve memory blocks without software intervention. As an example, the present invention is effective when if hardware and software elements share the same physical memory space.

In order to be able to allocate memory, the FLM monitors memory availability. According to an embodiment, the FLM utilizes a record that uses one bit of each designated block of memory. A block of memory can be any size. For example, a block of memory may have a pre-determined size that is a power of 2. During the memory allocation process, the value of the bit is used to indicate the status of designated memory block. For example, when the bit is set, the memory block is allocated. When the bit is clear, the memory block is free.

According to various embodiments, the FLM selects a block of memory via a multi-level search mechanism. For example, the number of levels required is dependent on the size of the memory, the established memory block size, and the amount of hardware available to implement the FLM.

To illustrates the present invention, we present a specific example in which the total memory size is 128 MB, the memory block size is 4 KB, and the number of search levels is 4. This example is provided merely to illustrate the an embodiment according to the present invention, which should not unduly limit the scope of the claims.

During the process of memory allocation, the FLM uses pointers to indicate the location of the memory. Typically, the format and size of the pointers are related to the size of memory space and the system configuration. To provide pointers to indicate the location of available memory, the FML conducts one more searches against its lookup tables to find available memory. For example, memory that are not being used are deemed available for allocation.

According to various embodiments, the FLM searches for available memory blocks. It is to be appreciated that the FLM is able to determine one or more sequential sets of available memory blocks based on its search algorithm. The ability to provide one or more sequential sets of available memory blocks provides various advantages of conventional techniques. For example, by having the search algorithm provide a set of blocks, rather than a single block, the FLM can completely hide the search time from the requestors of these pointers. This can be easily accomplished by setting the set size to be greater than the time it takes to perform a new search.

When the FLM allocate available memories, the FLM provides the requestors for memory pointers to available memory blocks one at a time. When only a few pointers pointing to the available memory blocks remain available for allocation, the FLM automatically performs a new search.

From the perspective of the requestors for memory pointers, a continuous stream of memory pointers without any latency delays is constant available, as the FLM performs searches before the last pointer is issued. In addition, if the set size is sufficiently large compared to the search time, the remaining cycles can be used to perform deallocation. This permits the FLM to be constructed from single-ported memory structures. It is to be appreciated that this is an added benefit since the FLM can be built from logic elements that are widely available and inexpensive to use.

The exact size of the set can be chosen by the designer. According to various embodiments, the restriction on the set size is fixed to be a power of 2. Usually, a smaller value increases the storage requirements of the FLM. On the other hand, a larger value results in a slightly less efficient allocation of memory. For a particular exemplanary design, the set size of 32 is used. The set size of 32 merely provides an example, which should not unduly limit the scope of claims.

To constructed searchable lookup tables for searching, tables are created at four levels. For example, the specifications for tables are according to the following parameters: 128 MB of memory, 4 k block size, four search levels, allocation block size 32. According to this example, the size of individual lookup tables according at each level is listed below in Table 1:

TABLE 1

| | |
|---|---|
| Level 1: 1 × 8 b | division factor: 8 |
| Level 2: 8 × 8 b | division factor: 8 |
| Level 3: 64 × 16 b | division factor: 16 |
| Level 4: 1024 × 32 b | |

The size of each level n is determined by the n+1 level. Hence, the lowest level is usually determined first. For this example, the process of determining table sizes starts at level 4. With a memory size of 128 MB, a block size of 4 KB, and a set size of 32, the total memory 128 MB is divided by 4 KB×32, which results in a table of 1024 entries.

For the remaining levels, the processing of determine table sizes need to decide on a division factor. Usually, the division factor is a tradeoff between the search complexity of that level and the number of levels that are to be created. For example, a typical number can be 8 or 16. For level 3, a size of 16 was chosen, which mandates that the number on entries will be 1024/16=64. By repeating this process, the values listed in Table 1 are determined.

Once the sizes of lookup tables are determined, they are constructed to a format that allows the FLM to perform necessary searches. According to an embodiment, each look-up table has a bit to indicate whether the corresponding entry in the lower level will be able to find an available block. If the bit is in the “set” condition, a search at the lower level will be unsuccessful. To find an available block, the search algorithm should continue its search until it finds a bit that is not in the “set” condition. Once found, the index corresponding to that bit is passed to the next level. The lower level selects the entry that matches that index that it receives and the search process is repeated.

According to an embodiment, by limiting the size to 8 or 16, the search algorithm is relatively easy to perform in a single clock cycle. It is to be appreciated that according to various embodiments of the present invention, different types of search algorithm may be used to implement the present invention. For example, a searching algorithm that can locate a zero or any zero, can be used in the present invention. For a particular embodiment, the search algorithm performs a leading zero search.

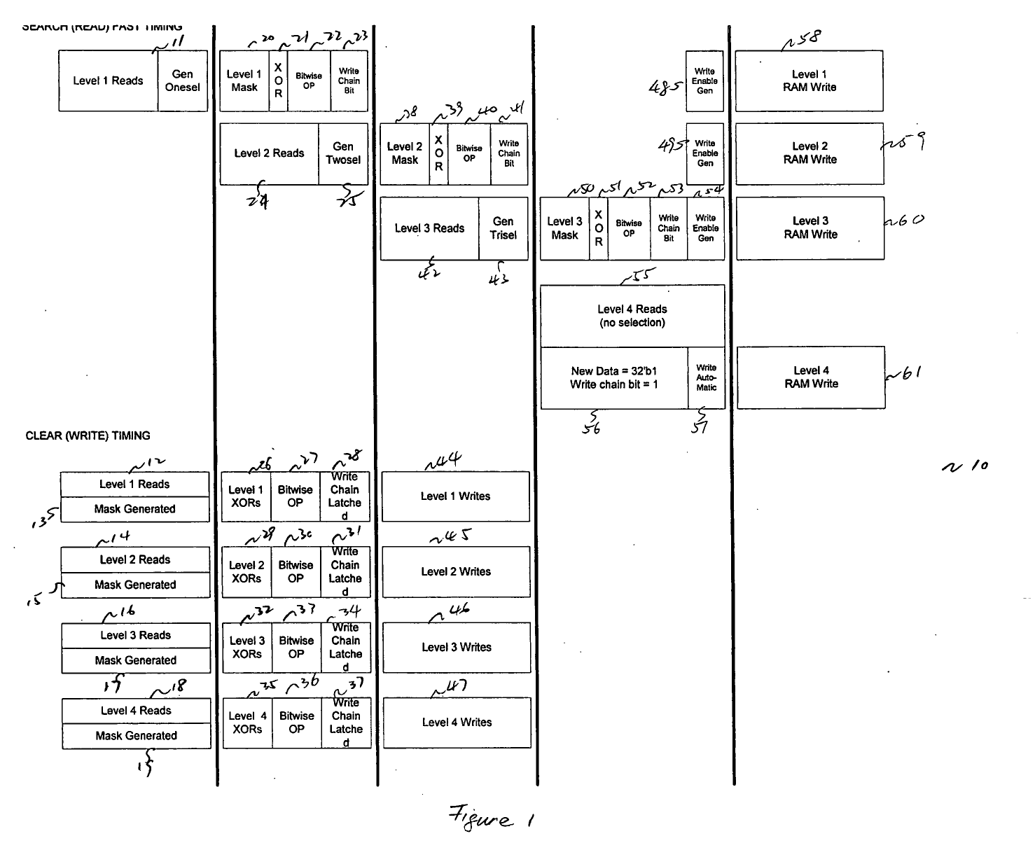

Typically, a search is conducted one level at a time. For example, a 4-level FLM requires a minimum of 4 cycles to traverse. FIG. 1 is a simplified diagram illustrating timing and operation according to an embodiment of the present invention. This diagram is merely an example, which should not unduly limit the scope of the claims. One of ordinary skill in the art would recognize many variations, alternatives, and modifications. More specifically, FIG. 1 illustrates timing for operation performed at each cycle. Usually, to begin a search, the top level lookup table is searched for a location that is equal to zero. Using the size of the level 1 look-up table, this search would return a 3-bit value that corresponds to the search result. This 3-bit value is then used to select the corresponding entry in the next level of the FLM.

Once selected, the second level entry is searched for any available location. This search is analogous to the previous one. For this exemplanary implementation, the search produces a 3-bit value for the chosen location.

This 3-bit value is then appended onto the previous 3-bit value to produce a 6-bit value. The process of searching and appending location values to the pointers repeats. As the search process descends down the FLM tree of memory locations, the FLM constructs an address by appending the current search result to the previous result. The new result is then used to index the next level. It is to be noted that the search method as described dictates how the sizes of lookup tables are determined.

Now referring back to the present example. Continuing with this method, the FLM at the next level selects one of its 64 entries (6-bit address) and performs a search on the corresponding 16 bits. The code representing this selection is a 4-bit value and it should be appended onto the current 6-bit address to form a 10-bit address. Once the 4th level is reached, the FLM uses the 10-bit address is used to determine a 32-bit word. As merely an example, the word has all of its bits set to zero. The FLM sets all of the 32 bits to one to indicate that the corresponding 32 blocks are now reserved.

According to various embodiments, the upper levels are not unconditionally updated. The FLM only updates the corresponding bit at level n when all of the bits at level n+1 are set. Likewise the bit at n−1 are updated only if all of the bits at n will be set once it is updated by the change at level n+1. For example, the setting of the bits at each level are performed simultaneously. It is to be appreciated that performing the updates simultaneously ensures proper operation and shortens the search time. Since the algorithm reserves all of the blocks at level 4, the level-3 bits are always be set. According to an embodiment, predicting a change at the upper levels is accomplished by using logic similar to the carry chain in a carry-look-ahead adder.

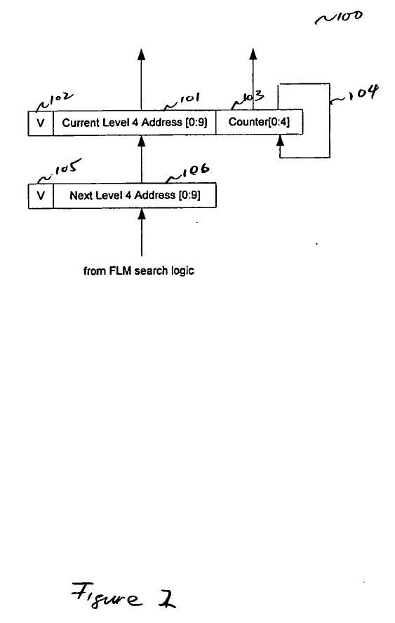

Once the search algorithm is complete, the FLM then passes the 10-bit address to be left appended onto a 5-bit counter. For example, the counter starts at 0 and proceeds to 31. The combination of the 10-bit address and the 5-bit counter value constitutes a 14-bit pointer to the reserved memory block. FIG. 2 is a simplified diagram illustrating the process of generating portions of a memory pointer based on lookup table searches according to an embodiment of the present invention. This diagram is merely an example, which should not unduly limit the scope of the claims. One of ordinary skill in the art would recognize many variations, alternatives, and modifications.

When a block of memory is requested, by either software or hardware, the current address/counter value is issued to the requestor. The counter is then incremented to a next value which corresponds to the next available memory block. As the counter approaches its roll-over point, the FLM should repeats the search algorithm to locate a new set of 32 pointers.

Since memory resource is limited, sometimes available memory blocks run out. If all of the memory locations are allocated, the FLM returns a null pointer and indicate to the requestors that no memory blocks available at this time. For example, the FLM may send a simple valid bit to indicate that no memory blocks available at this time.

To free up memory blocks to make memories available, the FLM deallocates memory. When the requester of the memory block has finished using its assigned memory pointer, it makes a deallocation request to the FLM. For example, this request includes the original 14-bit memory pointer. This pointer is used to simultaneously address all 4 levels of the FLM. Each level (except for level 1) uses two portions of the address to select a location. The selection process is analogous to the search algorithm: the portion produced at the n−1 level is used to select the corresponding entry in the array, while the portion produced at the current level is used to index a single location in that entry.

Depending upon applications, being selected during deallocation process does not cause the selected bits to be modified. For example, different levels have a different trigger conditions for modification. At the lowest level (level 4), the bit corresponding to the deallocated memory is always modified to indicate that the memory block is now available. At the level above this (level 3), the bit should is modified if all 32 bits are now equal to zero. This guarantees that if this set is selected again, all 32 entries will be available. Usually, it is crucial to the FLM operation, as all 32 entries must be available if future searches are to work properly. The remaining upper levels (level 1 and 2) are only modified if the level below them was previously all set and this condition is expected to change. For example, the upper levels are predicting whether or not a set of pointers is available at the lower level. If a set did not previously exist, and now does, a modification is required. On the other hand, if a set already previously existed, then the availability of an additional set does not change the status of this prediction.

In order to ensure proper operation, each level determines if whether to updated before any level is updated. Once this is determined, all levels are simultaneously updated. It is to be appreciated that the simultaneous modification ensures proper operation and shortens the time required to perform a deallocation. According to various embodiments, logic resembling a carry-look-ahead chain can be used to determine which levels should be updated.

To ensure the proper operation of memory allocation process, the FLM is able to perform reset and initialization operations. For example, at power-on reset, all entries at all levels are set to zero. This allows for an easy reset of the FLM, as there are no special requirements and no conditional operations are necessary. There could be other reset operation (e.g., partial reset operation) used for different situations. For example, if the search algorithm is designed to select the memory pointer whose value is all zeroes on the first attempt, the result of the initial search can be made immediately available by appending a 10b vector equal to zero to the 5-bit counter reset to all zeroes

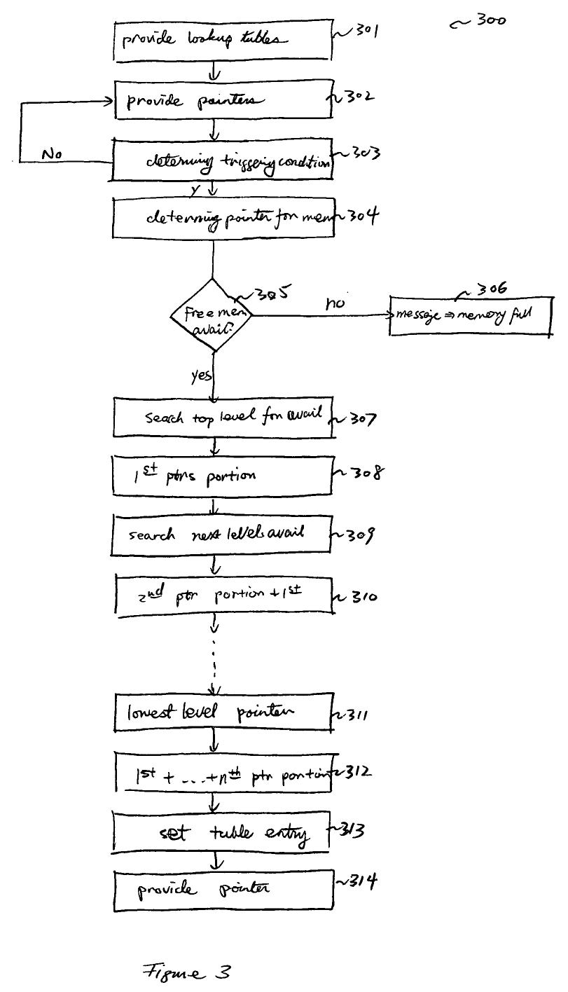

FIG. 3 is a simplified flowchart diagram illustrating the operation the FLM according to an embodiment of the present invention. This diagram is merely an example, which should not unduly limit the scope of the claims. One of ordinary skill in the art would recognize many variations, alternatives, and modifications. Various steps in FIG. 3 may be added, removed, replaced, re-arranged, repeated, overlapped.

According to an embodiment, the FLM is implemented at the hardware level of a system includes physical memory blocks that are to be made available to software applications.

At step 301, the FLM provides one or more lookup tables. For example, each of the lookup table includes indicators indicating an availability for one or more memory locations. According to an embodiment, each indicator is a single bit. The lookup tables are available at different levels. There is at least a top level and a bottom level. As the specific example illustrated above, a four-level table is used for a 128 MB memory space. Depending upon applications, sizes and the number of levels are determined by various factors, such as memory size, searching algorithm, etc.

At step 302, the FLM provides pointers to available memory blocks. It is to be appreciated that the pointers are pointed to one or more sequential sets of available memory blocks.

At step 303, the FLM determines whether a first condition is satisfied. For example, the first condition is associated with an availability of memory blocks being indicated by the at least one pointer. That is, pointers that are pointed to one or more sequential sets of available memory blocks are running out to a threshold range, the FLM initiates a process to search for more available memory blocks at step 304. Otherwise, the FLM stays at step 302 to continue providing pointers for memory request.

At step 304, the FLM determines a next pointer if the first condition is satisfied, the determining a next pointer comprises. As a example, the next pointer points to a memory location of available memory.

At step 305, the FLM determines whether there is any memory available. If all of the available memory have been allocated and thus there is no memory available, the FLM issues a message indicating that no memory available at step 306. If there are free memory available, the FLM begins searching for location of available memory at step 307.

At step 307, the FLM begins searching at the top level of the lookup table. For example, the FLM utilizes a simple searching algorithm that seeks table entries with leading zeroes.

At step 308, based on the search result from at the top level, the FLM determines a first pointer portion. For example, the first pointer portion includes the most significant digits of the next pointer.

At step 309, the FLM searches the next level for available memory. As a part of the search, the first pointer portion is used to select which lookup tables are to be searched.

Based on the search result from the step 309, the FLM obtains a second pointer portion at step 310. Steps 309 and 310 repeat to the next levels until the FLM reach the bottom level table.

At step 311, the FLM obtains a lowest level pointer based the search of the bottom level.

At step 312, the next pointer is determined by combining the values of pointer portions obtained from step 307 through step 311. For example, the next pointer is simply pointer portion values appended together.

At step 313, the FLM sets one or more indicators for the selected memory to indicate that the once available memory blocks are now used.

At step 314, the FLM provides the provides the next pointers so available memory blocks are ready to be used.

It is to be appreciated that the present invention provides various advantages. According to various embodiments, the present inventions provides a more efficient memory allocation technique. In addition, it is also to be appreciated that the present invention may be used in different types of systems. It is also to be noted that the present invention can be flexibly implemented using a wide range of components.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for allocating memory resource in a system comprising:
providing a plurality of lookup table, each of the lookup table including indicators indicating an availability for one or more memory locations, the plurality of lookup table including at least one top level lookup table and one or more bottom level lookup tables;
providing at least one pointer, the at least one pointer indicating one or more sequential sets of available memory blocks;
determining whether a first condition is satisfied, the first condition being associated with an availability of memory blocks being indicated by the at least one pointer;
determining a next pointer if the first condition is satisfied, the determining a next pointer comprises:
determining whether there is any memory available;
providing an indicator if there is no more memory available;
searching the at least one top level lookup table;
determining a first pointer portion based on a first result from the searching the at least one top level lookup table;
searching one of the bottom lookup tables based on the first result;
determining a last pointer portion based on a first result from the searching one of the bottom lookup tables;
providing the next pointer, the next pointer including the first pointer portion and the last pointer portion;
setting one or more indicators of the searched one of the bottom lookup tables;
providing the next pointer to a request for memory.

2. The method of claim 1 wherein the providing a plurality of lookup tables comprises:
determining a memory size;
determining a number of lookup table levels;
determining the plurality of lookup tables based on the memory size and the number of lookup table levels.

3. The method of claim 1 wherein one or more sequential sets of available memory blocks is characterized by a set size, the set size being associated with a memory size.

4. The method of claim 1 wherein the first condition comprises an indication the availability of memory blocks being indicated by the at least one pointer has reached a threshold range.

5. The method of claim 1 further comprising:
receiving an indication for freeing up of one or more memory blocks;
receiving a deallocation pointer, the deallocation pointer pointing to the one or more memory blocks;
updating one or more corresponding lookup tables from the plurality of lookup tables.
